(19) United States
(12) Patent Application Publication
(10) Pub. No.: US 2007/0266771 A1
(43) Pub. Date: Nov. 22, 2007

(54) Method of an Apparatus for Detecting the Presence of Signature Volatile Compounds From Materials in a Confined Environment

(76) Inventors: Stephen Latham Goldson, Christchurch (NZ); Terry John Braggins, Cambridge (NZ); Alan Leedham Hart, Palmerston North (NZ)

Correspondence Address: Lumen IPS, 2345 Yale Street, 2nd Floor, Palo Alto, CA, 94306, US

(21) Appl. No.: 10/562,717

(22) PCT Filed: Jul. 1, 2004
(86) PCT No.: PCT/NZ04/00137

§ 371 Date: Jul. 5, 2007

(30) Foreign Application Priority Data
Jul. 3, 2003 (NZ) 526815

(51) Int. Cl. G01N 1/40; G01N 1/10; G01N 1/22

(52) U.S. Cl. 73/31.07; 73/19.12

(57) ABSTRACT

A capture system to enable volatiles associated with targeted materials located within a confined environment to be trapped over a period of time to enable the volatiles to be concentrated. The capture system comprises a package having a “surface” which is constructed in a manner that it can be located within a confined environment to trap specific volatiles associated with the targeted materials. The captured volatiles are desorbed from the surface and are analysed and the results compared with known signature volatile profiles from the targeted materials.

### BACKGROUND TO THE INVENTION

Worldwide, approximately 90% of all cargo moves in containers, which equates to over 200 million containers being shipped annually. This global shipping system is a critical infrastructure for the global economy; however, it is also very vulnerable. Estimates are that overall less than 2% of all container contents are checked against manifests. The issues which are deemed to be the most important in relation to container security are container tampering, importation of illegal substances, and the threat of terrorist action. However, a less recognised issue but also very important is biosecurity (also known as quarantine), which is the prevention of the importation of unwanted pests and diseases. This applies to numerous countries but particularly to isolated locations like New Zealand and Australia, which have unique and susceptible ecosystems and biodiversity. The crucial importance of biological industries means that countries must have a very effective biosecurity system. It is estimated that in New Zealand 50 new organisms enter each year as unwelcome passengers.

Currently New Zealand lands over half a million shipping containers a year and they continue to cause grave concerns about biosecurity. A recent New Zealand analysis has shown that 24% of incoming loaded containers and 19% of empty ones were contaminated with biological material most of which occurred inside. Over 30% of loaded containers surveyed were found to have unmanifested wood packaging and 16% of all containers had wood packaging requiring immediate biosecurity action. Internationally, untreated wood is a major threat to biosecurity because of its ability to harbour pests and diseases; however, there are numerous other biosecurity threats including ants, wasps, termites, weevils, mosquitoes, snakes, spiders, scorpions and snails. Experience has shown that such species can inflict severe and ongoing damage to productive and indigenous ecosystems and public health.

Border security is a very important issue for most countries and requires the use of personnel and equipment and appropriate procedures to ensure that unwanted, dangerous or harmful materials are not imported. Typically efforts have focused on the interception of weapons, explosives, narcotics and illegal immigrants. A more recent aspect of border security is biosecurity. Biosecurity seeks to stop the unintentional import of organisms that could have a damaging effect on a country's agricultural industries, flora and fauna and ultimately economy.

There is crucial importance in biosecurity so a country can maintain its unique ecosystems (both productive and indigenous) and biodiversity. The threats to ecosystems are well known and in New Zealand include for instance Varroa mite, painted apple moth, clover root weevil, Argentine ant, gum leaf skeletoniser, red imported fire ant and many others. Therefore, it is necessary to have appropriate procedures to address biosecurity threats.

In New Zealand the Ministry of Agriculture and Forestry (MAF) is responsible for biosecurity. The MAF Quarantine Service (MQS) undertakes the role of ensuring compliance with biosecurity requirements at the border. As well as visual inspections, risk profiling and inspection of manifests or bills of lading, MAF currently use x-ray and detector dogs to contribute to their capabilities. With these capabilities it would seem that the interception of biosecurity threats posed by around 4 million passenger arrivals (and their luggage) every year is now well in hand. Similarly, it would seem that mail originating from other countries is well screened using a combination of X-rays and detector dogs.

However, such progress may not necessarily apply to air-freight while sea-freight remains an enormous logistical problem. The potential for accidental introduction of biosecurity hazards via these freight pathways remains very substantial. Even if biosecurity threats occur rarely in containers, the volume of traffic in New Zealand is large, growing at approximately 15% per annum and the impacts can be very severe. Biosecurity threats will only intensify with growing trade and tourism. MAF has a procedure whereby a proportion of the containers in any container shipment is singled out for close inspection because their contents have been identified as risk goods from the ship's manifest. In addition to this, other containers are inspected by accredited inspectors of MAF at unloading sites.

A consequence of this system is that many containers are not subjected to very close inspection. Currently decisions for relatively intensive searches are based on manifests that are not necessarily reliable. For example, containers often contain wood, in the form of packaging that does not appear on the shipping documentation. It is possible that this wood could include untreated, sap wood/bark which is that most likely to harbour pests (often as larvae) and diseases.

Comprehensive inspections are logistically very difficult, slow and expensive. Over a typical year, working day and night, the Ports of Auckland of New Zealand alone land a 12 metre equivalent container every two minutes.

The above details apply only for New Zealand. The issue of air and sea freight biosecurity applies also to other countries, where the number of containers and hence the logistics required to monitor them, is much larger.

Therefore, to improve and facilitate the current biosecurity procedures at borders, consideration is given to the use of volatile detecting technologies to provide additional and rapid enhanced detection and interception capabilities. There are a number of technologies that have been proposed to provide this additional capability, especially for the inspection of air and sea freight containers.

### PRIOR ART

X-ray imaging is well known and is already in use at airports to search for biosecurity threats. It is a non invasive technique, which provides an image of objects within containers and can also provide a chemical identification capability. There are x-ray systems which have been developed to search large containers for the presence of people, drugs or explosives. These systems are large, require a dedicated location on the wharf or airport and are very expensive. Furthermore, such systems make it very difficult to detect small or obscure biological threats such as insect egg-masses. For the larger containers, very high x-ray energies are required which can pose a potential hazard to the operators.

Other non-imaging techniques to investigate hidden objects in containers include the use of nuclear based probing beams which detect for specific chemicals or chemical compositions. Systems have been developed which can interrogate inside large containers for drugs and explosive materials. The technique uses a variety of nuclear (i.e. thermal neutron, pulsed neutron, fast neutron) or gamma-ray emitters to probe a container to detect the chemical make up of its contents. These probe beams interact with the objects inside, producing secondary gamma-ray emissions which are indicative of the compounds present and can be detected with suitable sensors, although the sensors do need to be located relatively close to detect the secondary gamma-rays characteristic of the materials.

A further technique that can also provide a chemical composition of hidden materials is nuclear quadrupole resonance (NQR). The NQR technique relies on emission of RF radiation into an object that thereafter is detected via the re-emission of radiation as the molecules of the materials relax. It is very sensitive to specific chemicals and has been used effectively for explosives detection.

The detection techniques described above are active systems, in that they probe the object with an electromagnetic or particle beam which is then detected via the response of the materials in the container have to this beam. There is a passive technique which has been developed to detect plant narcotics. It relies on the detection of the naturally occurring radiation emitted by potassium-40. K-40 is present in all plant materials. This system has been developed to detect these materials when they have been concealed in containers. The technique is non-invasive, particularly good at detecting marijuana, tobacco, and hashish. This technology requires a large, technically complex and expensive installation. It does not depend on line-of-sight, essentially being a ‘drive through’ system which, for container traffic, could be relatively slow. There are also issues about minimum sample sizes that can be detected.

For all the techniques discussed above, the detection equipment is expensive and requires large, dedicated facilities with trained operators. Many of the techniques require the truck or container to be driven through the equipment to allow interrogation. It is desirable to develop approaches which do not rely on the use of large and expensive systems to detect biosecurity and other threats and which is essentially non-invasive of the environment in which the threat is contained.

An alternative approach that has been developed (for narcotics and explosives) is that of vapour or volatile chemical detection. There has been considerable effort placed in developing sensors and associated equipment to detect for trace levels of explosives or drugs on people or in their baggage at airports. There have also been a number of developments specifically aimed at large freight containers or sea containers which have their air sampled to detect for vapours or particulates associated with narcotics or explosives. Some of the prior art is now described.

WO 98/17999 (Neudorfl) describes a capability which focuses only on the detection of cocaine. It discusses a methodology where air is extracted from a shipping container and is passed over ‘filters’ to capture cocaine odours. These filters could be tissue cloth or mesh made from cotton, silanized glass wool, metal or Teflon. They could also have coatings to enhance the binding of vapours of interest. These odours are then presented to ion mobility spectrometers (IMS), IMS mass spectrometry (MS), gas chromatography (GC), GC-MS or GC-MS-MS, equipment and the presence or not of cocaine determined. It was also identified that a further chemical, ecgnidine, is indicative of the recent presence of cocaine and the presence of this chemical as well as cocaine improved detection ratios (by reducing false alarms). Typically air was withdrawn from a container onto a filter and a measurement made at a later time. Where no holes existed in the container, these could be drilled to allow extraction of air. High volume samples were preferred in order to facilitate rapid extraction of air for sampling.

EP 0 447 158 A2, (Danylewych) covers the application of using IMS systems in detecting trace levels of narcotics or explosives. It mentions two other patent specifications, U.S. Pat. No. 4,580,440 and U.S. Pat. No. 4,718,268 which teach the use of mass spectrometers for similar applications. The specification also teaches that particulates within the containers can also enhance vapour concentrations when the particles are left for an extended period of time. Danylewych provides a detailed working of the IMS system and enhancements that provide improved detection capability compared with existing know-how.

U.S. Pat. No. 4,580,440, (Reid) discusses the application area of containers at sea ports. It mentions that naturally occurring particulate matter within the containers will have additional time to absorb vapours, these vapours may be associated with contraband. Agitation is an important step of moving these particulates around the container, which are then sucked out of the container and into a measurement system.

Canadian 2,129,594, (Nacson) is aimed at general drug and explosives detection and in particular the sampler/desorbing unit for collating vapours for the subsequent analysis. It is aimed at improved filtering to provide better discrimination of vapours of interest, removing higher and lower volatile compounds (and unnecessary particulates) specifically for an IMS detector system. Nacson also mentions the application of the system to shipping containers.

WO 99/38015, (Anderson et al) teaches a method for detection of narcotics in closed containers. Air is driven into the container via vent holes and drawn out via another outlet. It is also possible to drill holes, or insert a tube between rubber seals. The air flowing in can be of a nature to disturb particulates, which can then be drawn out via the outlet. It mentions that the air could be either presented to trained detector dogs or used for chemical analysis to determine the likelihood of narcotics being present. The air can also be blown over a filter which could later be presented to a tracker dog. No specific methodology for presenting the filter to the tracker dogs (on which volatiles are present) is provided by Anderson.

Additionally U.S. Pat. No. 5,795,544, (Matz) teaches a means to introduce an external gas into a container to purge the air from within. This can be presented to a gas analyser for the detection of illegal substances. It could also then be used to fumigate the container, if that is deemed necessary. Matz also mentions a means for detecting the presence of unwanted insects and parasites. No mention is made of specific detection means, it relates only to getting air into and out of a container.

In all the above examples there is no mention of detecting for the presence of biosecurity threats. There are some examples in the prior art of detecting for pest or insects by monitoring the carbon dioxide (CO₂) levels in confined spaces.

U.S. Pat. No. 3,963,927 (Bruce) describes a system to detect the CO₂ which is respired by insects. It uses a system which purges a volume of space, where insects may be allowed to build up CO₂. This aids in detecting CO₂ from insects against the natural background levels. Essentially a material containing insects is placed within a chamber in this apparatus.

U.S. Pat. No. 6,255,652, (Moyer) describes a similar methodology which uses the presence of CO₂ to indicate when insects, in particular termites, are present in a building structure. The technique uses an infrared CO₂ detector. A needle is passed into a wall space to draw air out and into the analyser. This is compared with one taken from the vicinity. An increase of only a few parts per million can be indicative of an infestation.

The prior art describes techniques that rely on extraction of the air from a container through appropriate air extraction equipment, which is captured and sometimes concentrated, prior to it being measured by conventional analytical equipment such as GC, MS etc. To extract the air there needs to be an appropriate hole or holes in the air or sea freight container, which if not present, need to be drilled in the container. Some of the techniques also require the container to be shaken prior to extracting the particulates/vapours in order to capture materials with specific vapour absorbed within or on them.

In the following description and claims, the expression ‘targeted materials’ means any material that is to be identified within a confined environment. Although the invention is particularly concerned with the detection of unwanted materials such as bio-security and other threats, it is to be understood the technology herein disclosed can be utilised to detect a wide range of materials that may be located within a confined environment.

### OBJECT OF THE INVENTION

It is an object of this invention to provide an improved means for and method of detecting the signature volatile components of targeted materials within a confined space which does not suffer from the disadvantages of prior known systems and methods.

### DISCLOSURE OF INVENTION

Accordingly in one aspect of the invention may be said to comprise a method of detecting the signature volatile compounds of targeted materials in a confined environment comprising the steps of:
providing a package which includes a ‘surface’ as herein defined said package including means to enable a flow of air to pass over the surface to enable volatile compounds from the targeted materials carried in the air to be trapped by the surface,
locating the package within the confined environment for an extended period of time,
desorbing the trapped volatiles from the surface, and
comparing the desorbed volatiles against a data base of known profiles of signature volatile compounds of the targeted materials.
Preferably the surface comprises an adsorbent or absorbent material which when suitably treated will release the trapped volatile compounds.
Preferably the package is located within the confined area for a sufficient time to enable signature volatile compounds to be concentrated on the surface and wherein at the expiration of the time of concentration, the package is removed from the confined environment and the volatile compounds are released from the surface for analysis.
Preferably the package is located within the confined environment to enable signature volatile compounds of the targeted materials to be adsorbed on the surface and the package includes a transmitter to enable the surface to be interrogated by a device external of the confined environment.
Preferably the device includes means to enable air to be drawn over the surface for a suitable period of time.
Preferably air is drawn over the surface for specific periods of time
Preferably the package includes a complementary detection device which enables results to be communicated telemetrically.
Preferably the package includes electrical pump or fan adapted to move air over the surface.
Preferably the package includes an electrical storage battery to power the electrical pump or fan.
Preferably the surface comprises an adsorbent or absorbent material which when suitably treated will release the trapped volatile compounds.
Preferably the treatment for the release of volatile compounds from the surface comprises a controlled heating of the surface.
In another form the method of detecting the signature volatile compounds of targeted materials in a confined environment comprises the steps of:
providing a package which includes a ‘surface’ as herein defined, locating the package within the confined environment for an extended period of time,
passing a flow of air over the surface for a period of time to enable volatile compounds emitted by the targeted materials and carried in the air within the confined environment to be trapped by the surface,
desorbing the trapped volatiles from the surface, analysing the desorbed volatiles and
comparing the desorbed volatiles against a data base of known profiles of signature volatile compounds of the targeted materials.
In another form the invention may be said to comprise a method of detecting the signature volatile compounds of targeted materials, said means comprising:
a package adapted to be located within the confined environment,
means associated with the package to enable a flow of air within the confined environment to be passed through the package,
a surface as herein defined located within the package and positioned so the flow of air will pass over the surface to enable volatile compounds in the flow of air to be absorbed by the surface,
means to enable the volatile compounds trapped by the surface to be desorbed, and
means to analyse the desorbed volatile compounds and to compare the profiles of the compounds against a data base of known profiles of signature volatile compounds of targeted materials.
Preferably the device includes means to enable air to be drawn through the package and over the surface for a suitable period of time.
Preferably the surface comprises an adsorbent or absorbent material which when suitably treated will release the trapped volatiles.
Preferably the means to enable a flow of air to pass over the surface comprises an air pump or a fan integral with the package.
Preferably the enclosed environment comprises a shipping or aircraft container.

### BRIEF DESCRIPTION OF THE DRAWINGS

Exemplifications of one form of the invention will now be described with the aid of the accompanying drawings wherein:

FIGS. 1A and 1B are schematic representations of devices utilised to sample air inside shipping containers.

FIGS. 2A through 2I illustrates the effect of sampling time for selected terpene compounds adsorbed from samples under experimental conditions.

FIGS. 3 and 4 are GC-FID chromatograms of air samples from an empty shipping container.

FIGS. 5, 6 and 7 are total ion chromatograms of air sampled from different shipping containers.

### DESCRIPTION OF PREFERRED EMBODIMENTS OF THE INVENTION

The present invention relates to a different approach which could be widely deployed to detect and identify volatiles associated with targeted materials that are located within a confined environment.

An absorbent or adsorbent material (herein the ‘surface’) is placed within the environment such as a shipping container to sample for varying durations the confined air-space and thereby concentrate volatile compounds that may be emitted from the targeted materials. On arrival at the destination, this ‘surface’ is removed from the container and after being treated in a suitable manner, the released volatiles are presented to a suitable detector system using, for instance, chemical or electronic analysis.

Signature volatile compounds emitted specifically by targeted materials will be pre-concentrated in the container by the device. These volatile compounds will then be released and analysed using an externally located detector system that will inform the appropriate authorities of the presence of the targeted materials. This provides an indication of whether the container may contain the targeted materials, therefore requiring a more detailed search or other investigation.

Alternatively, the trapped volatiles could be detected by a complementary detection device inside the container and the results communicated telemetrically. This information may then be used to decide whether the surface should be interrogated further by an external device with more comprehensive analytical capability and thereby provide more information on the likely presence of the targeting materials present in that container.

The ‘surface’ is housed within a package that allows air to be drawn over it throughout the journey or a substantial part of the journey from the original port of loading of the container to its final destination. The ‘surface’ can take various forms and could be tissue, cotton, glass wool, foam, a membrane or other absorbent or adsorbent material. In one form, the package may take the form of a small container that includes an air-pump or fan which can draw air continuously, or continually, over the surface for a period of time that equates for instance, to a typical shipment time or as a discrete sample at the end of the voyage. The package preferably includes appropriate means to fix it onto the door or side wall of the container which may be a temporary or permanent fixture. The ‘surface’ could also be made of a material which is more specifically absorbent/adsorbent to the volatiles of interest, but may be resistant to air/humidity dominating the absorption/adsorbent process. Power is preferably provided by a battery in order to aid air flow across the surface. It is also expected that in certain circumstances the air pump/fan may not be required as diffusion of vapour may be sufficient over the journey time from original port to destination.

Preferably but not necessarily the package may include a filter in the air flow system to reduce large particulates/dust from being absorbed, provided these do not then become surfaces upon which volatiles of interest may be captured on the filter. This could be utilised in conjunction with a self checking monitor to indicate if the device failed to pump air during a journey, or the package had been tampered with.

In a modification it is proposed that through adaptation of the shipping containers, the device and hence the ‘surface’ could be accessed without opening the main doors by providing an appropriate hatch in the container.

On arrival of the container at its destination the ‘surface’ is extracted from the container and placed in a device that provides appropriate treatment to the surface such that any captured volatiles are desorbed. Such devices are well known and in one form heat is to desorb the volatiles. Preferably, depending upon the type of the detector system, the temperature of the heater unit is controlled in a manner whereby different volatiles associated with different materials may be released at different times. These desorbed volatiles would then be presented to the detector. This allows versatility in being able to detect materials, of which the signature volatiles have not yet been profiled. Alternatively, or in addition, the device could remain in the shipping container and treatment to the surface could be incorporated in the device such that the trapped volatiles are detected by a complementary detection device inside the container and the results communicated telemetrically.

This methodology which leads to concentration of signature volatiles provides an effective solution to the problem of rapid screening of containers, as well as linking with existing border protection capabilities, such as for instance the detector dogs or analytical devices such as ion mobility spectrometers which are commonly used at borders. It also provides a methodology which achieves a concentrating capability for any volatiles which may be present, as the transit journey times allow greater chance of capture of any trace levels of odours which may be present in the container. A further advantage is that the package will obviate the need to drill holes in containers in order to sample the air space when no appropriate holes are normally present.

The ‘surface’ could be used once for every journey, or after desorption, could be replaced into the container for subsequent journeys.

An alternative methodology for the ‘surface’ is that it is placed inside selected containers on arrival at the destination port. This package would have an air flow system and could be left for a short period of time, for instance a few hours to sample the air in the container. After this time the ‘surface’ could be interrogated in a similar manner as described above.

Alternatively, the volatile compounds in or on the ‘surface’ could be presented to a commercial volatile chemical analytical tool such as mass spectrometer, gas chromatography system, or related chemical sensing technology etc. to determine the content of the volatiles.

In a further modification, the volatile compounds in or on the ‘surface’ could be presented to a volatile chemical analytical tool such as a surface acoustic wave (SAW) sensor or related chemical sensing technology attached to the ‘surface’ device residing in the container. This dispenses with the need to open the container door and allows for rapid detection of targeted materials. Information can be communicated to the exterior of the container by telemetry.

Additional benefits could flow from having the ‘surface’ present in most shipping containers. In the first instance it is unlikely that all containers would be interrogated. However, all the surfaces could be removed after the voyage and taken to a laboratory for inspection and analysis. This would allow a detailed database to be developed which could improve existing risk profiling intelligence. This database could then be used to improve selection criteria for shipping and aircraft containers for subsequent interrogation.

Such a technology and methodology as herein described can also be used for the detection of explosives, narcotics and weapons and used for monitoring in locations other than freight containers.

Solid phase microextraction was designed for analysing volatile and semivolatile compounds and has been successfully applied to the analysis of a wide range of organic compounds including terpenes. The rapid sampling technique of Koziel et al. (“Air sampling with porous solid-phase microextraction fibers”. Anal Chem. 72, (21) 5178-5186, 2000) was used to allow samples of air to be drawn from the inside of shipping containers. A portable dynamic air sampling device was designed based on the devices reported in Augusto et al., (Design and validation of portable SPME devices for rapid field sampling and diffusion-based calibration, Anal. Chem. 73(3), 481-486, 2001).

Various forms of the invention and of tests carried out using the process of the invention will now be described with the aid of the accompanying drawings.

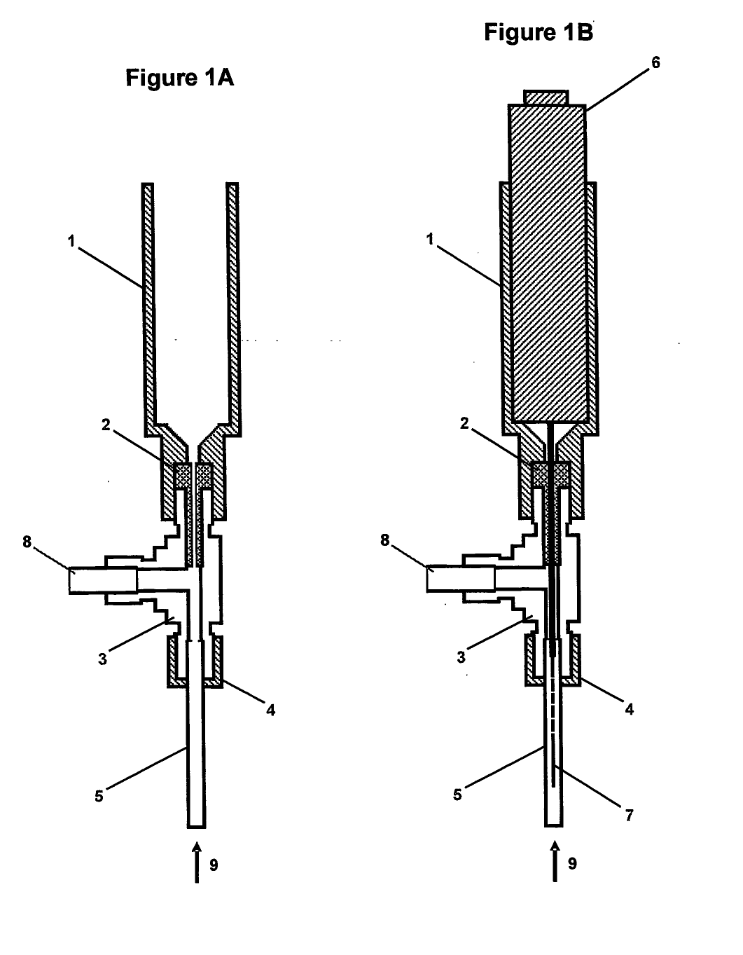

FIGS. 1A and 1B illustrate schematically a sampling device that can be employed to detect the VOC's. As illustrated in these Figures, the device which is based on the Augusto et al design (see above) includes a stainless steel cup 1 and a Teflon restrictor 2 which communicates with a T junction 3 having one end formed to accept a nut 4 which locates a tube 5, the bore of which will communicate with the bore of the T junction 3. FIG. 1B illustrates the device of FIG. 1A but including an SPME holder 6 with fibre exposed. The active SPME surface 7 is located within the bore of the tube 5. The T junction includes a port 8 for connection to a suitable pump (not shown in the drawings). It is to be understood the sampling device is illustrated in diagrammatic form only and various constructions can be utilised to effect the sampling.

As can be seen from the FIG. 1B, the SPME holder slots into the top of the unit and the needle passes through the Teflon restrictor 2 just above the T-junction 3 to keep the system air tight. An air pump (not shown in the drawings) was used to draw air samples over the exposed SPME fibre at a controlled rate in the direction of the arrow 9. The fibre, when exposed, lies inside the unit at the position indicated in FIG. 1B.

In the examples given here Carboxen™/polydimethyl siloxane fibres were used for sampling because they have a specificity for the compounds of interest, and are best suited for field sampling. Before use the fibres were conditioned at 300° C. in a GC inlet for at least 1 hr to ensure that the fibres were clean.

Either GC-FID or GC-MS can be used to analyse the trapped volatiles, the instrumental methods are as follows.

GC FID:

Instrument: Hewlett Packard 5890 Series II

Column: DB5-MS capillary column (30 m×0.25 mm i.d., 1.0 μm film thickness).

Head pressure: 13 psi (split 50:1)

Temperature program: 40° C. for 4 min; 300° C. at 12° C./min, final hold for 4 min.

Detector temperature: 280° C.

Trapped volatiles were desorbed for 3 min into a splitless injector at 300° C. and a 0.75 mm i.d. injector liner was used for the SPME desorptions.

Data was collected and the chromatographic peaks were identified by retention time. Additionally, concentrations of the terpenes were estimated using the relevant peak areas from a liquid injection of a solution of lime oil in hexane (1%). A volume of 1 μL was injected with the chromatographic conditions being the same as above except that the injection was carried out split with a 2.3 mm i.d. split/splitless inlet liner and the injector temperature at 280° C.

GC/MS

Instrument: Agilent 6890 with an Agilent 5973 mass detector.

Column: ZB5 capillary column (30 m×0.25 mm i.d., 0.25 μm film thickness)

Head pressure: 16 psi (constant flow mode)

Temperature program: 40° C. for 4 min, 190° C. at 6° C./min, 300° C. at 20° C./min, final hold of 2 min.

Detector conditions: Electron-impact ionisation at 70 eV, transfer line 280° C., source 220° C.

Volatiles were desorbed pulsed-splitless (25 psi) at 280° C. for 3 min. The GC was equipped with a microseal septum to alleviate problems associated with septum bleed and a 0.75 mm id injector liner designed for SPME desorption. Data was collected in the mass range m/z 40-550 and total ion chromatograms were recorded. Compounds were identified by comparison with library mass spectra and GC retention time data.

Optimisation

To optimise the sampling rate and sampling time a standard environment containing a mixture of terpene compounds was generated using a foil-laminate bag (ca. 280 mm×380 mm) that had an inlet with septum for sampling through. The bag was filled with approximately 5 L of nitrogen and sealed. A small volume of essential oil was then injected through the sampling inlet into the bag. To obtain a reasonable range of mono- and sesquiterpene compounds, which represent the compounds emitted by wood, a mixture of lime oil (1.2 μL), which is high in monoterpenes and manuka oil (3.5 μL), a source of sesquiterpenes, was used. The bag was left for at least 18 hr to allow the volatiles to equilibrate within the headspace.

A Teflon tube fitted at the distal end with a needle of the same dimensions, was attached to the end of the adsorption device. The SPME holder was placed into the unit and the needle on the Teflon tube was then used to pierce the septum of the inlet to sample the headspace in the bag. The pump was turned on for about 15 seconds (without exposing the fibre) to flush out the system, after which the fibre was exposed for the chosen sampling time and rate. After sampling, the SPME holder was removed from the unit and the fibre directly desorbed into the GC.

The sampling device was tested at three sampling rates (50, 100, and 150 mL/min) for 30 seconds and it was found that the amount of compounds adsorbed at each flow rate were not significantly different. This is because at linear flow rates greater than 10 cm/s the rate of adsorption onto microporous SPME fibres becomes independent of flow rate. In the present device, this linear flow rate would be equivalent to a volumetric flow rate of about 40 mL/min. Therefore, for all further experiments a flow rate of 100 mL/min was used to ensure a stable rate of adsorption.

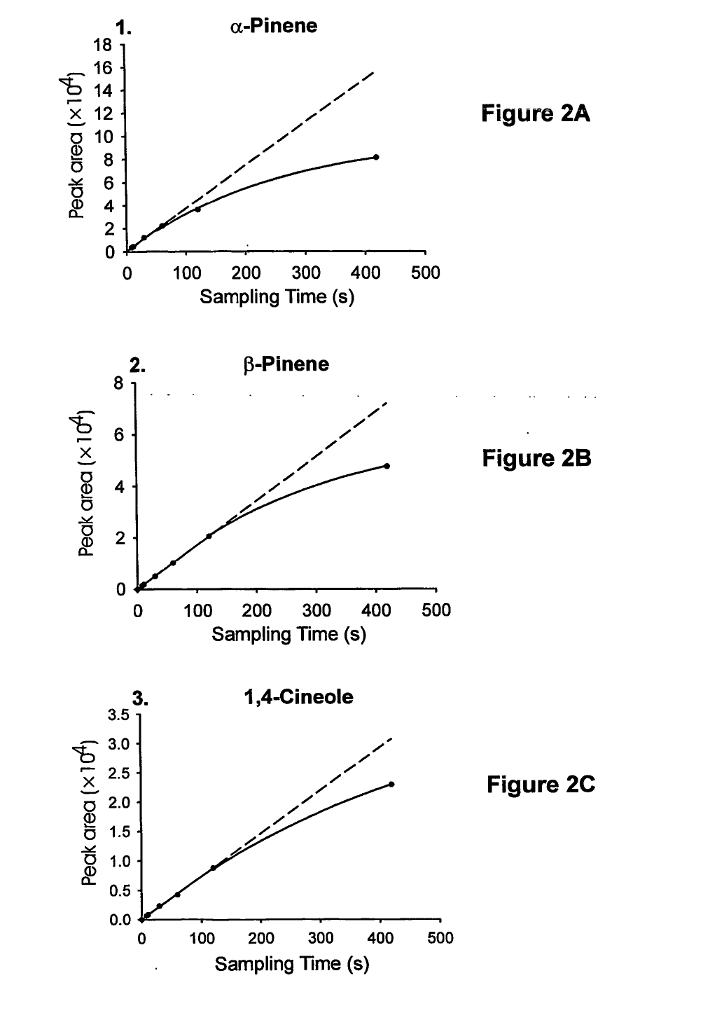

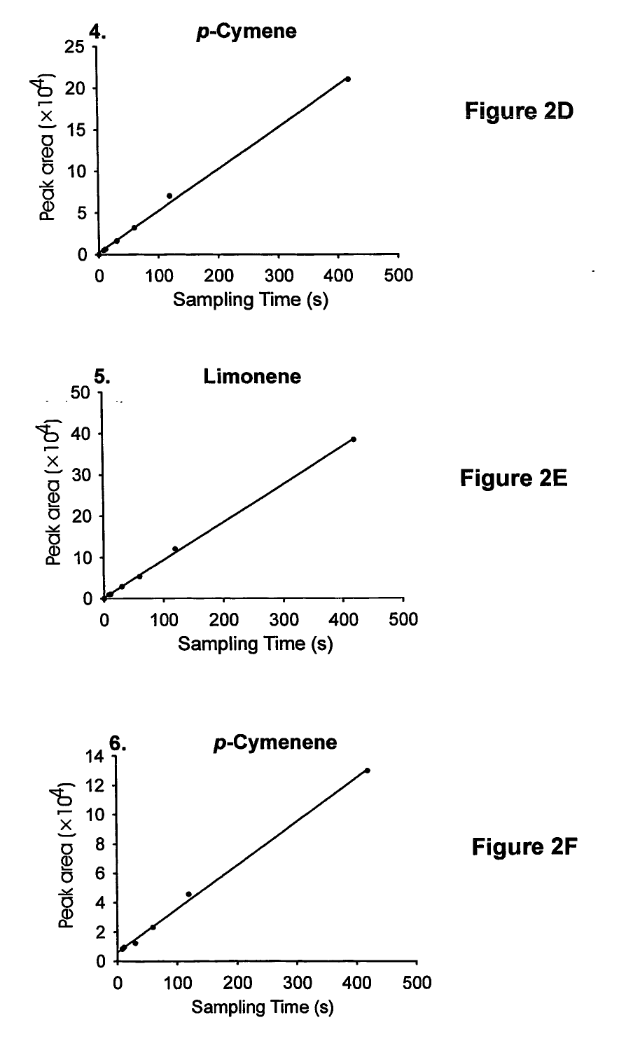

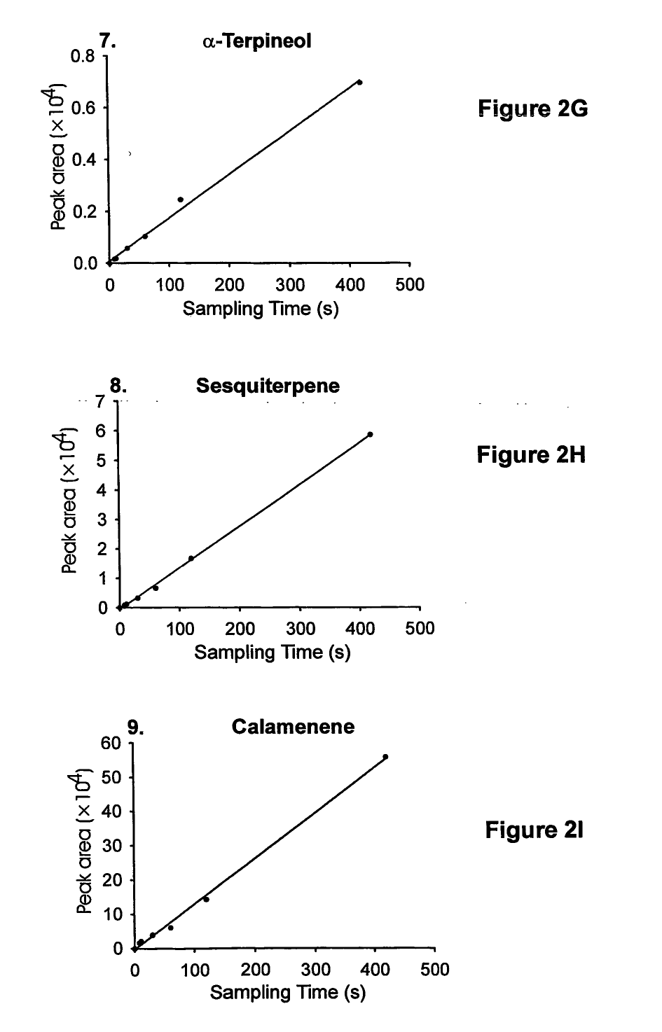

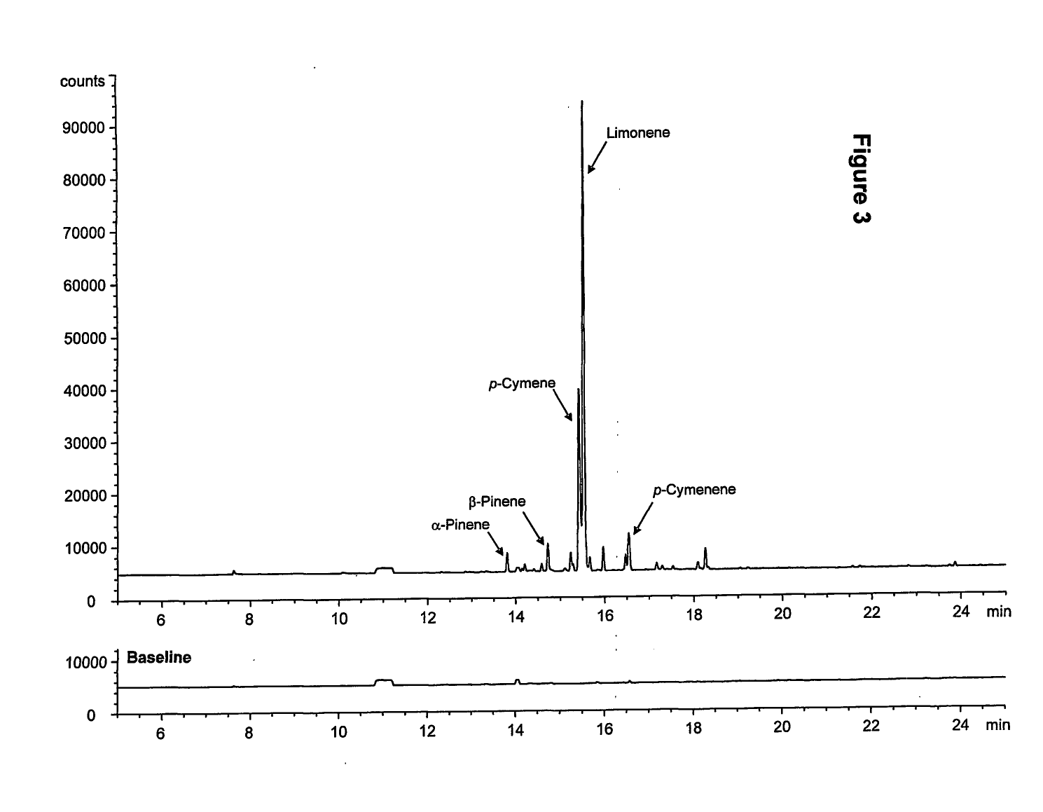

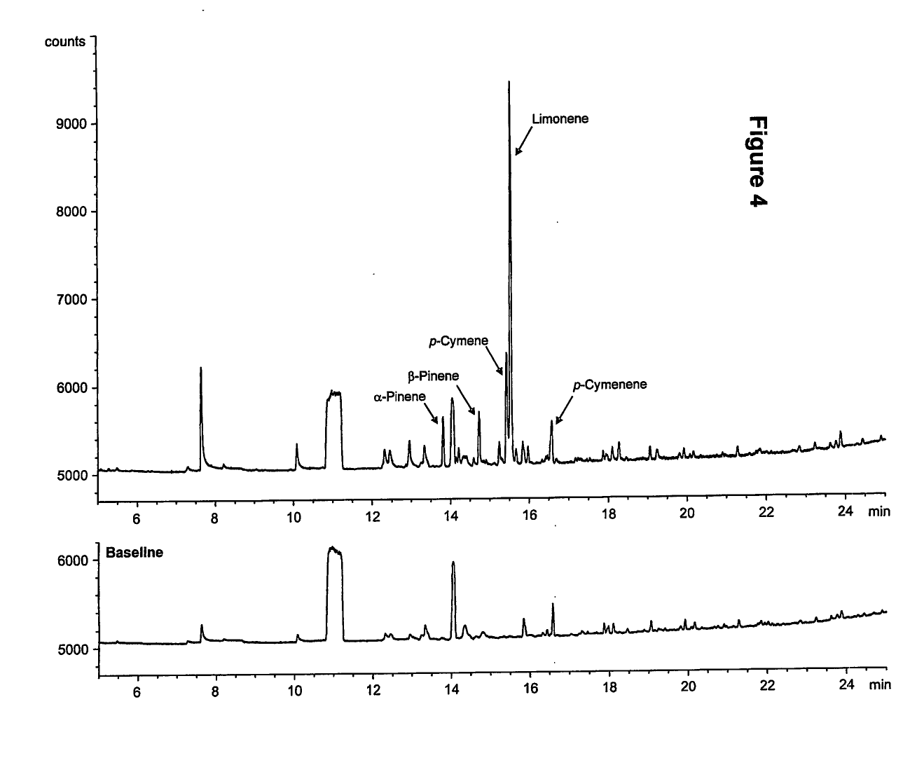

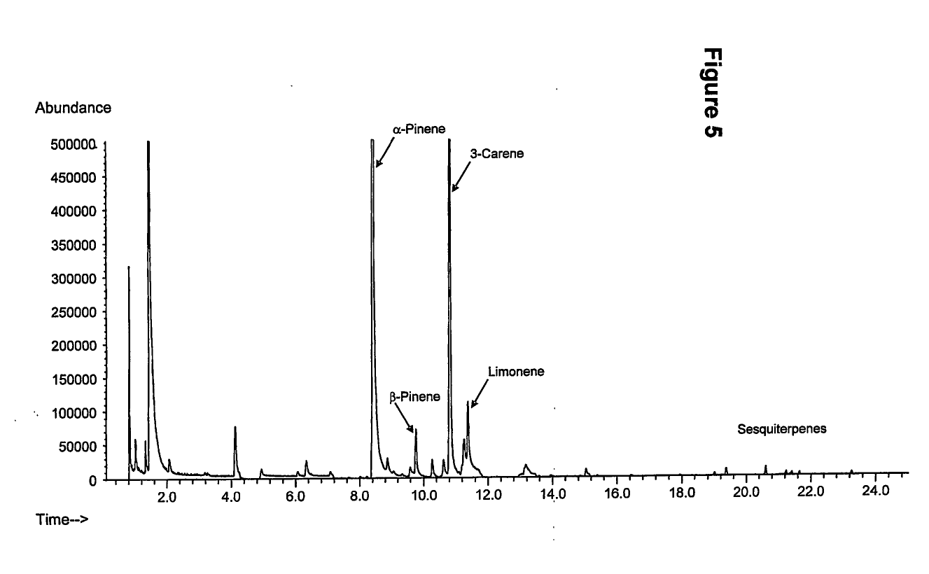

To determine the optimum sampling time at the chosen flow of 100 mL/min the amount of compound adsorbed for times ranging from 10 seconds to 7 minutes was measured for several different terpenes as illustrated in FIG. 2.

The plots are numbered in order of retention time and demonstrate that at the concentrations used the amount of terpene adsorbed with time from p-cymene onwards (with respect to GC retention time) show good linearity up to the 7 min sampling time. In contrast, the earlier eluting terpenes such as α-pinene, β-pinene, and 1,4-cineole show a decrease from linearity with the β-pinene and 1,4-cineol curves beginning to decline after 2 minutes, while the α-pinene curve declines just before 2 minutes. This suggests that, at the concentrations used for this experiment, after 1-2 minutes of sampling the fibre surfaces are becoming saturated and the early eluting terpenes are being affected by the competitive nature of binding onto the Carboxen™-PDMS fibre. At this point other factors such as boiling point and polarity start to play a part in the adsorption process, such that the later eluting compounds start exchanging with the early eluting compounds already bound to the fibre. These processes are also likely to be concentration dependent (i.e. they are likely to start earlier at higher concentrations) although as the concentrations of volatiles within shipping containers should be lower than those used here competitive binding phenomena should not be a problem. For all further work a 30 second sampling time was chosen to ensure that sampling remains in the linear range for all compounds of interest. Reproducibility under these chosen conditions of 100 mL/min for 30 seconds was acceptable, with a CV of less than 15% obtained for all compounds analysed (n=12).

Detection of Volatiles in an Empty Container.

A 20 ft (33,000 L) container was utilised for these experiments. The trapping device was placed on a table inside the container and the container air sampled for 30 seconds at 100 mL/min. As the device had a large dead volume the system was flushed out for 30 seconds at 100 mL/min prior to placing the SPME fibre into the device. This was to ensure the container air was being sampled and not the residual air in the trapping device. The trapped volatiles were then analysed by GC-FID.

The container was sampled several times at different places within it to get an indication of the variation in the background volatiles. The background within the chromatographic region of interest remained reasonably consistent over time and position within the container (results not shown); therefore, it was deemed the background would not pose any problems with during further experimentation.

The trapping of representative wood volatiles was then evaluated. This was carried out by releasing known volumes (500-3000 μL) of lime oil into the container by pipetting oil onto two glass fibre filters which were placed on watch-glasses at the back of the container. The container doors were then closed for at least 24 hr to allow the internal air to equilibrate before sampling. After each evaluation, the container was left open for at least 2 days to allow the volatiles from the oil to dissipate before further samples were taken and analysed. Background measurements were made to verify that the sample volatiles were fully dissipated before continuing with the next sample.

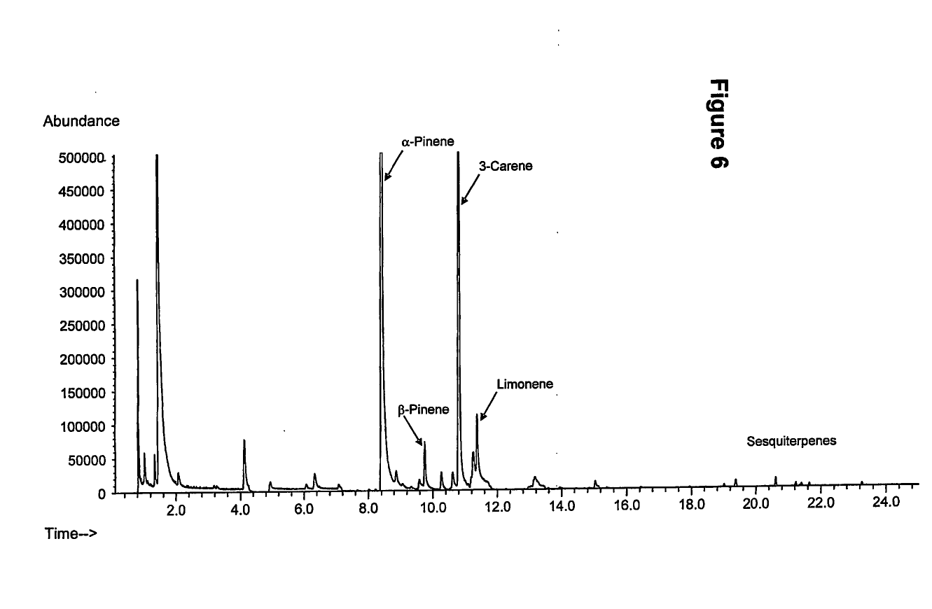

FIGS. 3 and 4 show two representative chromatograms obtained after releasing lime oil into an empty container. FIG. 3 shows the chromatogram obtained from 3 mLs of oil, which gives a total concentration of about 80 ppb, and is approximately the same as that used in the bag for the optimisation. At this concentration the major peaks are well above the background (see the insert) and easily detected. The limonene is the most dominant peak at an approximate concentration of 35 ppb but other compounds such as α-pinene and β-pinene, which are between about 1-2 ppb, are also easily detectable.

FIG. 4 shows the chromatogram for 500 μL of lime oil (12 ppb). This chromatogram is essentially the same as that for the oil at the higher concentration (FIG. 3) except for the expected drop in peak intensities (compare scales). As a result of this reduction in peak intensity of the terpene compounds in the oil, the background peaks (see the insert) are relatively larger but the terpene peaks are still easily detected. A volume of 1 mL was also tested but since a similar response was obtained (with the peak intensities being between the two illustrated concentrations) this chromatogram is not shown.

From the chromatograms a limit of detection (LOD) for the terpenes was estimated to be in the order of 50-100 ppt when using GC-FID for detection. It is impossible to equate this LOD to an amount of wood because the level of volatiles emitted by wood is highly dependent on the type of wood and how green it is. In a previous study it was shown that volatiles from freshly cut wood about the size of a match-box (ten 1 cm³ blocks) were detectable in an empty container.

Detection of Volatiles in Fully Laden Containers

Fully laden containers were analysed at a shipping port. Sampling of about 6 containers per day (with 21 containers analysed in total) was carried out just after the door of the container had been opened; at this point the volatiles inside the container would be at their maximum. To minimise dispersion of the volatiles, the door of the container was only opened enough to slip a Teflon sampling tube which was attached to the end of the adsorption device, inside. The pump was turned on for about 30 seconds before exposing the SPME fibre and then the container air was sampled for 30 seconds at 100 mL/min. After sampling, the SPME needle was removed from the holder, capped with a Teflon plug and placed in a screw-capped test tube. The tubes were kept on ice until returned to the laboratory where they were stored in a refrigerator at 4° C. until analysed the following day by GC/MS. Each SPME fibre had been pre-desorbed for 5 min at 300° C. and placed in screw-cap tubes prior to transport to the field.

On each day, a background sample of the surrounding air outside the containers was also taken by exposing one of the SPME fibres to the port air for 30 seconds. Examination of these background samples showed a number of compounds (results not shown). Most of these were from the fibres themselves (e.g. siloxanes) but a few early eluting peaks were picked up from the environment. These included chloroform and a few low boiling point alkanes. No terpenes were found indicating that the majority of compounds detected in the container samples originated from the sampled containers and not from the surrounding environment.

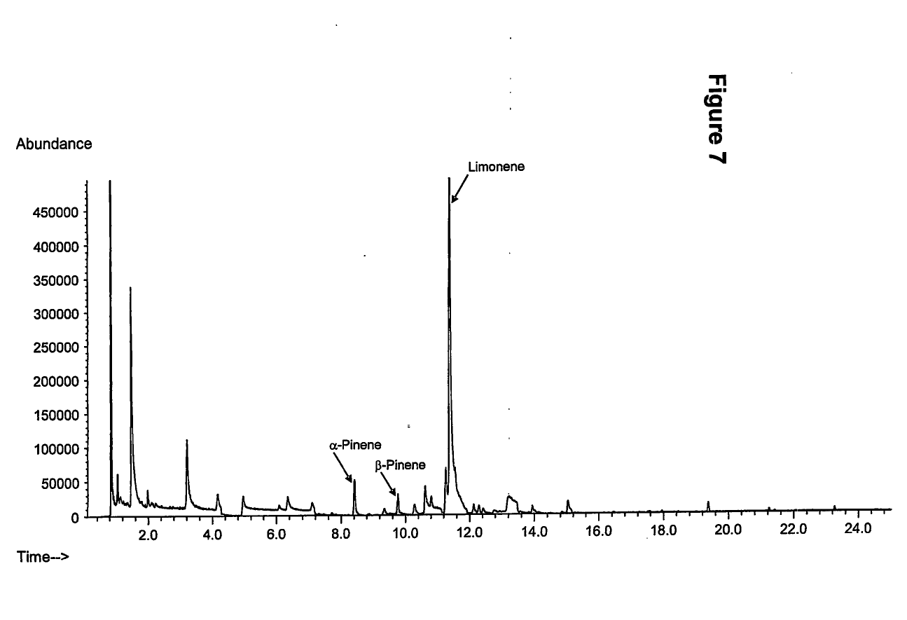

Chromatograms obtained for air sampled from three containers are shown in FIGS. 5, 6 and 7. FIG. 5 shows the sample from a container that contained coiled sheets of steel packed with wood. FIG. 6 shows the chromatogram from a container with drums of epoxy resin stacked on wooden palettes. The third container as illustrated in FIG. 7 was packed with cardboard boxes on wooden palettes.

A number of different terpenes were detected in each of these containers. The more volatile monoterpenes (e.g. α-pinene, β-pinene, 3-carene, and limonene) were the most abundant, but the less volatile sesquiterpenes were also detected in two of these containers. Full characterisation of the sesquiterpenes was not possible due to their very similar mass spectra, but at least four different sesquiterpenes were identified in each container based on the presence of the molecular mass ion of 204 and their retention time. Each chromatogram has a different profile of terpene compounds, suggesting that a different type of wood was present in each of the containers.

The results showed that, based on the detection of terpenes, the absence or presence of wood was correctly identified in 18 of the 21 (85%) containers tested. In 2 out of the 21 (10%) containers wood volatiles were detected when no wood was visible from the door. One of the two containers contained cardboard-boxed washing machines and it is possible that there was wood either inside the boxes or at the back of the container which was not visible. However, due to the nature of this study it was not possible to fully unload this container to verify its contents. The second container contained old sawmill machinery and although there was no wood visible there may have been residual sawdust present, which could have been the source of the trace terpenes detected. There was also one container which had a small amount of wood inside but no wood volatiles were detected. The wood was in the form of wheel blocks which appeared to be very dry and therefore may have been too dry to emit terpenes at a detectable level.

### CONCLUSIONS

These results have demonstrated that trapping volatiles onto a Carboxen™-PDMS fibre using dynamic SPME is an effective way of detecting wood packaging inside shipping containers. A good success rate of correctly identifying the presence or absence of wood based on the detection of wood volatiles was achieved.

Concentrations of volatile compounds in the order of parts per trillion were detectable using this technique which indicates the potential of dynamic SPME for trapping volatiles from a much wider range of contents inside shipping containers. These could be used to identify the presence of not only of biosecurity threats, as well as the presence of the frequently referenced threats to border security, such as drugs, explosives or illegal immigrants. It is also apparent that this technique can be simply adapted to locate or identify a large variety of targeted materials.

Small devices, based on this trapping technology and housed inside containers, which were able to identify the presence of these materials would have great potential in increasing the security of shipping container transport.

It is also considered that such a vapour capture, concentration and identification system as described above could be used in other confined areas such as the hold of an aircraft to detect any specific volatiles indicative of biosecurity, narcotics or explosives. It has particular relevance when the cargo or baggage is left in the confined area for an extended period of time such as luggage lockers.

The present invention includes three aspects as follows:

1. The capture system by which volatiles associated with targeted materials are trapped with the trapping being performed over a suitable period to enable the amount of the volatiles to be concentrated. The capture system comprises a package which includes a ‘surface’ which is constructed in a manner that it can be located inside a shipping or aircraft container to adsorb/absorb specific volatiles indicative of the targeted materials. This will enable sufficient concentrations of trace volatiles to be captured using a variety of different ‘surface’ materials which may consist of glass wool, filter paper, sponges or a number of proprietary capture systems.

2. The desorption system. Various methods of enabling the captured volatiles to be desorbed from the ‘surfaces’ can be used. For instance specific heating cycles and temperature ranges/times will allow different types of volatiles to be differentially released from the ‘surface’. Volatile release can be measured using GC or other analytical equipment.

In a modification it is possible to provide a hand held system which can be used remotely to desorb vapours.

3. The detection system. The volatiles released by the description system can be analysed and compared against a data base of profiling intelligence that has been built up of the bio-security and other threats. The detection will be performed either in situ or remotely, such as in a laboratory using known techniques, preferably based on commercial detection tools such as mass spectrometers, gas chromatography systems, ion mobility spectrometers, mass spectrometry, selected ion flow tube mass spectrometry systems and the like.

By reason of the present invention it is possible to provide a higher level of detection sensitivity in remote situations than by simply sucking air out of a container and placing this onto a filter which is presented to the detector.

Having disclosed various preferred forms of the invention, it will be apparent to the skilled reader that various modifications and amendments can be made to the specific means and to the method disclosed and still lie within the general concept of the invention. All such modifications and amendments are intended to be included in the scope of the present invention.

1. A method of detecting the signature volatile compounds from targeted materials in a confined environment comprising the steps of:
providing a package which includes a ‘surface’ as herein defined said package including means to enable a flow of air to pass over the surface to enable volatile compounds from the targeted materials carried in the air to be trapped by the surface,
locating the package within the confined environment for an extended period of time,
desorbing the trapped volatiles from the surface, and
comparing the desorbed volatiles against a data base of known profiles of signature volatile compounds of the targeted materials.

2. The method as claimed in claim 1, wherein the surface comprises an adsorbent or absorbent material which when suitably treated will release the trapped volatile compounds.

3. The method as claimed in claim 1, wherein the package is located within the confined area for a sufficient time to enable signature volatile compounds to be concentrated on the surface and wherein at the expiration of the time of concentration, the package is removed from the confined environment and the volatile compounds are released from the surface for analysis.

4. The method as claimed in claim 1, wherein the package is located within the confined environment to enable signature volatile compounds of the targeted materials to be adsorbed on the surface and the package includes a transmitter to enable the surface to be interrogated by a device external of the confined environment.

5. The method as claimed in claim 1, wherein the device includes means to enable air to be drawn over the surface for a suitable period of time.

6. The method as claimed in claim 5, wherein air is drawn over the surface for specific periods of time

7. The method as claimed in claim 1, wherein the package includes a complementary detection device which enables results to be communicated telemetrically.

8. The method as claimed in claim 1, wherein the package includes electrical pump or fan adapted to move air over the surface.

9. The method as claimed in claim 8, wherein the package includes an electrical storage battery to power the electrical pump or fan.

10. The method as claimed in claim 1, wherein the surface comprises an adsorbent or absorbent material which when suitably treated will release the trapped volatile compounds.

11. The method as claimed in claim 1, wherein the treatment for the release of volatile compounds from the surface comprises a controlled heating of the surface.

12. A method of detecting the signature volatile compounds from targeted materials in a confined environment comprising the steps of:
providing a package which includes a ‘surface’ as herein defined,
locating the package within the confined environment for an extended period of time,
passing a flow of air over the surface for a period of time to enable volatile compounds emitted by the targeted materials and carried in the air within the confined environment to be trapped by the surface,
desorbing the trapped volatiles from the surface, analysing the desorbed volatiles and
comparing the desorbed volatiles against a data base of known profiles of signature volatile compounds of the targeted materials.

13. A means of detecting the signature volatile compounds from targeted materials, said means comprising:
a package adapted to be located within the confined environment,
means associated with the package to enable a flow of air within the confined environment to be passed through the package,
a surface as herein defined located within the package and positioned so the flow of air will pass over the surface to enable volatile compounds in the flow of air to be absorbed by the surface,
means to enable the volatile compounds trapped by the surface to be desorbed, and
means to analyse the desorbed volatile compounds and to compare the profiles of the compounds against a data base of known profiles of signature volatile compounds of targeted materials.

14. The means as claimed in claim 13, wherein the device includes means to enable air to be drawn through the package and over the surface for a suitable period of time.

15. The means as claimed in claim 13, wherein the surface comprises an adsorbent or absorbent material which when suitably treated will release the trapped volatiles.

16. The means as claimed in claim 13, wherein the means to enable a flow of air to pass over the surface comprises an air pump or a fan integral with the package.

17. The means as claimed in claim 13, wherein the enclosed environment comprises a shipping or aircraft container.
